(19) United States
(12) Patent Application Publication
(10) Pub. No.: US 2008/0109292 A1
(43) Pub. Date: May 8, 2008

(54) Voice-enabled workflow item interface

(75) Inventor: Dennis B. Moore, Hillsborough, CA (US)

Correspondence Address: SAP/BLAKELY, 1279 OAKMEAD PARKWAY, SUNNYVALE, CA, 94085-4040, US

(73) Assignee: SAP AG

(21) Appl. No.: 11/592,802

(22) Filed: Nov. 3, 2006

(51) Int. Cl. G06Q 10/00; G06Q 99/00

(52) U.S. Cl. 705/9; 705/1

(57) ABSTRACT

Methods and apparatuses enable providing a workflow work activity of a particular interface type to a different interface type. The work activity can be potentially worked on in the different interface type. In one embodiment, the work activity can be completed in the different interface type and cleared from the system.

### FIELD

Embodiments of the invention relate to workflow interfacing, and more specifically to voice-enabled interfacing of workflow items and cross-interface interaction on workflow items.

### BACKGROUND

Employees of companies regularly perform work that is part of a greater overall project or process. Companies that accomplish tasks through business processes typically have differing workflows for different aspects of one or more business processes. The workflows are in turn broken out into work activities or tasks that are to be performed by a certain person, or someone in a particular role within the organization. Often, a work task by one person must be completed for the workflow to continue. Workflow items may be generated in one of various formats, depending on the item. For example, an email may present an employee with a particular task in a workflow (e.g., approve/disapprove a project budget, provide suggestions on a presentation that is being prepared, etc.). Traditionally, the various backend systems through which workflow items may be generated are separate and distinct within the enterprise. For example, voicemail and email are handled in different systems.

The conventional systems fail to provide adequate interfacing for an employee to perform work on workflow activities. Access to, and interaction with (i.e., work on), workflow activities is traditionally limited to the environment of the system in which the workflow activity was generated. The lack of interfacing limits the ability of an employee to accomplish his or her work.

### SUMMARY

Methods and apparatuses enable providing a workflow work activity of a particular interface type to a different interface type. The work activity can be potentially worked on in the different interface type. In one embodiment, the work activity can be completed in the different interface type and cleared from the system.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1 is a block diagram of an embodiment of an application framework with run-time and design-time components.

FIG. 2 is a block diagram of an embodiment of a composite application architecture.

FIG. 3 is a block diagram of an embodiment of a work center having cross-system workflow interfacing.

FIG. 4 is a block diagram of an embodiment of a user device with a work center having cross-system workflow interfacing.

FIG. 5 is a block diagram of an embodiment of a workflow interface manager.

FIG. 6 is a block diagram of an embodiment of wireless user device coupled to an enterprise having a workflow interface manager.

FIG. 7 is a flow diagram of an embodiment of a process for providing access in one system to compatible workflow items of another system.

FIG. 8 is a flow diagram of an embodiment of a process for accessing a workflow activity in a non-native system.

FIG. 9 is a flow diagram of an embodiment of a process for completing a workflow activity in a non-native system.

### DETAILED DESCRIPTION

As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

Workflow activities of various workflows are integrated into a universal worklist. The worklist is accessible via any of multiple channels or interface types. As used herein, a channel or interface type refers to means and methods of connecting to a particular system or device. For example, an email system is traditionally interfaced through an email client, a mobile phone is traditionally interfaced through a voice interface, etc. A workflow activity may be native to a particular interface type. As used herein, a workflow activity is native to an interface type in the sense that the workflow activity is generated in a particular system, or generated for a particular system. For example, a workflow activity may be generated and transmitted to a user's email, meaning the workflow activity is native to the email system interface. A non-native interface type is an interface to any system other than a system native to the workflow activity (e.g., a voice channel on a mobile device is non-native to an email workflow activity). A workflow interface manager is provided as means to allow access to a workflow activity from a non-native interface type.

Workflow activities from multiple systems with different interface types are aggregated in a universal worklist accessible to any interface type. The workflow interface manager enables access to the worklist items (i.e., the workflow activities) from the various interface types or channels. In one embodiment, all channels have access to all worklist items, meaning all items are viewable from all channels. However, not all items are necessarily able to be presented in all channels. Thus, the workflow interface manager determines whether a workflow activity requested from a particular interface type is accessible (to be presented) in a requesting or another, non-native, interface type. In one embodiment, a format conversion may be provided to present a workflow activity in a non-native interface type (e.g., text-to-speech conversion of an email or a workflow alert).

The workflow interface manager can provide unification of a calendar, a “to do” list task lists, universal worklist of work items, etc., and provide the utilization of voice technology to receive alerts, process commands to complete work items, etc. The work items can originate from any source, meaning from any original or native interface type. The workflow interface manager can convert alerts, approvals, reports/dashboards, and workflow items to speech, and process the items via voice and/or touch-tone phone keys. The workflow interface can enable queries via voice or touch-tone phone keys to produce text-to-speech output. The workflow interface can enable data entry forms via text-to-speech, and enable data entry via voice or touch-tone phone keys. The workflow interface can integrate voice applications into voice mail, for example, for authentication and single sign-on, as well as enabling voice-mail keys to trigger commands on a workflow item such as save, reject, delete, etc.

Unlike previous attempts at unified messaging, the workflow interface manager unifies different systems in a universal worklist, which allows access to workflow items of any of the different systems by another, and may allow processing of the workflow item in one of the other different systems. For example, the workflow interface manager can initiate alerts and send them, for example, to voicemail. The alerts could then be processed via the voicemail system or another voice system. The workflow interface manager can allow workflow items to be accessed and processed through a collaboration tool, a personal productivity or personal information management website, a dashboard, etc.

When a workflow item or task appears in a worklist, the item can be rendered into any of the various systems. As used herein, “render” or any of its derivatives refers to presenting an item from one interface or channel in another interface or channel. Conversion may take place to enable an item to be presented in another interface/channel. Presenting the item may include making data visible and/or audible through any of a number of interface types. The various systems that have the various different types of interfaces can be referred to as environments. The worklist items can be updated and worked on from the various different environments. A client (e.g., an email client, a mobile telephone, etc.) of any environment may be able to provide access to a user to work on items from one or more of the environments, even items that are traditionally incompatible.

Thus, in one embodiment, all work items that come to a user could be rendered as email, or calendar items, or “to do” items on a task list, or as faxes, etc. Note that even though an item may be accessible from a particular environment, not all items are necessarily well suited for presenting an item and allowing a user to process the item. For example, voice messages may not render well into an email message. However, as a contrary example, voice handling of items from other systems may work well in many cases.

In one embodiment, when a work activity is generated on a worklist, the activity may have priorities, dates, etc., assigned (for example, by the person generating the work). Certain rules may be attached to particular work activities. Rules could be applied by the person or process generating the work activity, as well as the person receiving the work activity. Rules applied by the person receiving the work could include categorizing by work type (for example, by managerial role), by sender (e.g., employee, client, supplier), by associated corporation (e.g., for the ACME corporation), by subject matter (e.g., all patent matters). Rules applied by the entity generating the work activity could include rules about how a particular activity can be rendered (for example, do not allow processing by a particular interface type).

The workflow interface manager can operate with a process-oriented workflow client that provides tasks by work activity and all message types in a single interface. The workflow client provides a view of different workflow items, which can be specific to requests for specific types of information (e.g., “show purchasing tasks”). The information may be classified by metadata associated with the task in the backend enterprise system. The metadata can provide information that indicates the origination of the task, what classification it belongs to (e.g., purchasing), what role should handle the task (e.g., manager), etc. The workflow client can be specific for the different kinds of tasks (e.g., a “purchasing workflow client” that shows pending worklist items, KPI (key process indicator) information, etc., in a dashboard view). The client could also provide an indication of what processes a user could start from the dashboard, for example, purchasing something, or initiating a fraud detection process, etc. A workflow client can be enabled to render the workflows into formats suitable for processing by various channels, or various types of interface types.

For example, in one embodiment, the workflow interface manager enables all items available from a workflow client into voice. Thus, if a user of the workflow client is offsite and has only cellular access, the user can access a workflow item via voice and have an automated system read voice mail to the user. The workflow interface manager can be selective, for example, being enabled with analytics or other processing or determination capability. When a task is not suitable to be rendered to voice, the workflow interface manager can select to not provide processing access to the task. Thus, although the user may have access to “see” all tasks, some tasks may or may not be accessible for processing, depending on whether a determination engine of the workflow interface manager determines the task is able to be rendered to and processed by a particular interface type. For example, the workflow interface manager may have rules tables or rules databases that specify task type, input needed on a task, size of the information in task, whether the task has attachments, or any other significant criterion, and what is or is not allowable given the specifics.

The following provides a non-exclusive list of possible examples of conditions for rendering workflow items into voice. Commenting or requesting comments on work items could be performed via voice, depending on the complexity required to respond. For example, a voice response to a budget request, or an employee evaluation request could be provided. Notifications could also be rendered to voice. Approvals or requests for decision could be performed via a voice channel, for example, through verbal response or through keypad button selection (e.g., press ‘1’ for approval). Responding to reports may not work well in voice, for example, if there are attachments that must be considered to provide the response, etc.

Note that in each scenario, the handling of the workflow item via the voice channel is not the equivalent of picking up the phone and making a phone call to handle an item. In such a scenario, the workflow item traditionally would still need to be responded to or cleared via the workflow interface, whether or not the item was adequately handled via a phone call. In contrast, the voice channel can directly access and interact with the workflow systems in the enterprise backend, and the item handled. The information generated on the voice channel can trigger the completion of the workflow activity and move the workflow along, all without access to the workflow from another interface.

In one embodiment, a multimodal, or simultaneous access via multiple interface types is possible. There may be a case where simultaneous access to a workflow activity with multiple clients could make sense. For example, a slideshow presentation may not make sense without hearing the person presenting it. Thus, the workflow interface manager can enable a multi-modal version of access to allow a user to process a workflow activity with more than one client at a time (e.g., voice could accompany a presentation).

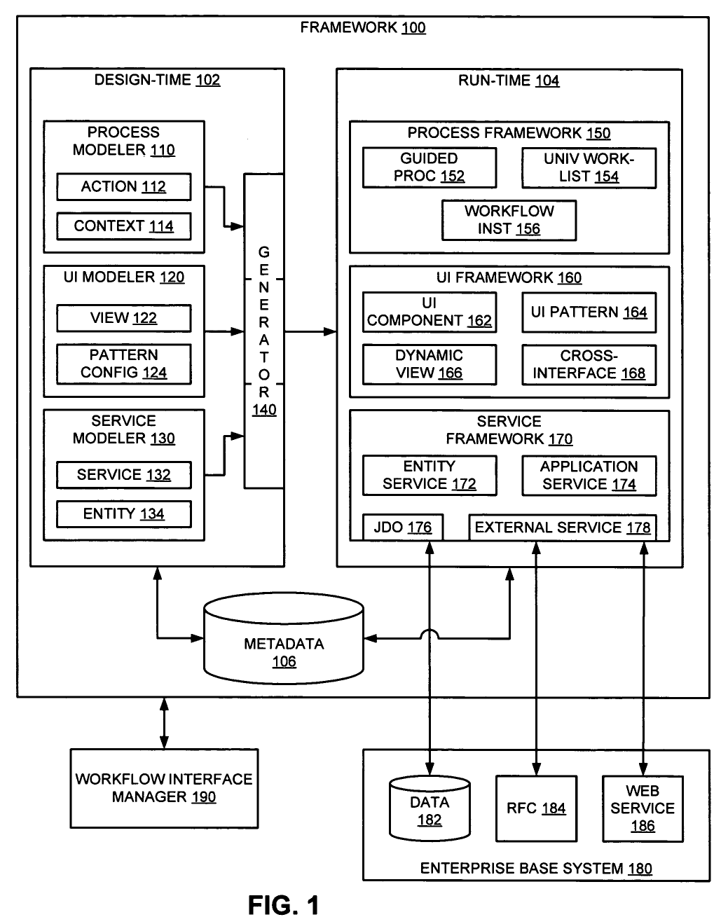

FIG. 1 is a block diagram of an embodiment of an application framework with run-time and design-time components. In general, framework 100 leverages and enhances underlying enterprise base system 180, which could include one or more elements of data and/or functionality to perform operations. Framework 100 provides a structure with which to generate composite applications, which are modeled/generated software. Composite applications may support semi-structured processes, handle event-driven and knowledge-based business scenarios, and/or support collaboration. In one embodiment, composite applications support the JAVA stack. The composite applications may be broken down into various portions, each of which may be separately generated/modeled. The composite application portions may, in one implementation, be implemented as Enterprise Java Beans (EJBs), and in other implementations, the design-time components may have the ability to generate the run-time implementation into different platforms, such as J2EE, ABAP, or .NET.

Framework 100 generally allows composite applications to work within existing system environment by decoupling the applications from the underlying enterprise platform. Decoupling the applications from the underlying enterprise platforms may include providing communication to back-end systems via a central interface and providing a back-end-independent object model. Framework 100 includes design-time components 102 and run-time components 104. Design-time components 102 include modeling components with which to generate a composite application, and one or more mechanisms to generate the model. In general, design-time components 102 are responsible for developing composite applications that are executed by run-time components 104.

Design-time components 102 include process modeler 110, UI modeler 120, and service modeler 130. These modelers are not necessarily separate entities, although they may be. Furthermore, additional modeling tools may be provided within design-time components 102. In general, the modelers allow for integrating business objects, business services, business processes, user interfaces, etc. Process modeler 110 includes the capability of generating one or more actions 112, which represent the various phases of a process. Each action 112 has an associated operation or operations that represent the work of action 112. Action 112 may be part of an activity that is generated, or part of a guided procedure that provides interaction with the user on performing operations. In an embodiment where action 112 is part of a guided procedure, process modeler 110 includes information with each action 112 to execute the guided procedure.

Process modeler 110 also includes context 114, which provides awareness to the process regarding the enterprise system in which it is operating. Where a function is used from an application that does not understand the enterprise system, process modeler 110 can wrap the function in metadata to incorporate the function into the system.

User Interface (UI) modeler 120 provides the ability to generate a user interface and provide views of data/processes that can be accessed through a composite application generated with framework 100. UI modeler 120 can generate any of a number of views 122 on data. In one embodiment, standard views or patterns are used for each application developed. A user interface may include certain elements from a template. Thus, user interfaces may have certain common components and provide a familiar look and feel across multiple applications. Certain views are dependent upon the environment in which the application is executed. Views 122 may include capability to dynamically generate views based on roles, authorizations, and activities associated with the application. Pattern configuration 124 of UI modeler 120 allows the use of templates and standard UI components.

Service modeler 130 enables a composite application to access data. Data objects are accessed via services. Thus, service modeler 130 provides the service-oriented model through which data is accessed. In one embodiment, service modeler 130 provides an enterprise service architecture (ESA), where applications are developed through a service-driven, rather than a model-driven, architecture. A service-driven architecture provides access to callable services that provide interaction with data. Service modeler 130 includes service 132, which represents one or more service that may be provided. Service 132 may include, but is not limited to, guided procedures, object monitoring, standalone actions, programs or functions, etc. Entity 134 of service modeler 130 provides a component generated to access a service within the enterprise, or a web service. An enterprise or web service as described here refer to entities within a network (either within a network of the enterprise, or within the Internet) that are addressable and provide a capability based on a request and/or input parameters (e.g., flight booking).

Generator 140 represents one or more components to transform the model into run-time components. In one embodiment, generator 140 is a single component, while in alternate embodiments, generator 140 is multiple components.

Run-time components 104 provide instantiation of the items modeled with run-time components 102, and include various frameworks within which object or service instances operate. Process framework 150 represents a framework under which one or more instances of processes can execute. For example, process framework 150 may include guided procedure 152, universal worklist 154, and/or workflow instance 156. Guided procedure 152 represents an instance of a guided procedure as discussed previously. Universal worklist 154 provides a list of all workflow or process items available to a user. A workflow or process may be available to a user through an operation requested of the user on the workflow/process, and/or through the user having a responsibility authorization with respect to the workflow/process. Universal worklist 154 may be used to access work centers for each process available. Workflow instance 156 provides an example of one or more workflows that represent work requested of a user. The workflow may have one or more actions for the user to perform.

UI framework 160 provides abilities to render views on data and processes. In one embodiment, UI framework 160 includes a view manager (not shown) that provides dynamic management of content that will be displayed/presented to a user. UI framework 160 may include UI component 162, which represents one or more elements of a user display. In one embodiment, UI component 162 includes elements for rendering the display in a web browser, although another environment could be used. In one embodiment, a separate application viewer could be used. UI pattern 164 provides patterns and standard elements for rendering the user interface. UI pattern 164 may provide UI component 162. UI pattern 164 may be a template with various components 162 to provide buttons, links, text, etc., that may be standard to every application generated, or partially customized with instance-specific data.

In one embodiment, UI framework 160 includes dynamic view 166. Dynamic view 166 represents a view that has one or more dynamic components, and may change the content of the application that provided to a user. Dynamic view 166 changes content based on an authorization of a user. The content can be changed dynamically to reflect personnel structuring changes (e.g., moves, promotions, terminations), and change of the underlying data or service content. In one embodiment, UI framework 160 includes cross-interface module 168 that provides cross interfacing services from one channel to another, or from one interface type to another. Through cross-interface module 168, UI framework 160 can render workflow activities native to one interface into a format accessible in another interface.

Service framework 170 implements the data access through services available to the user. A user may have access to one or more entity services 172, application services 174, JAVA data object (JDO) services 176, and/or external services 178. Application service 174 represents services local to the composite application, or directly accessible by the application. JDO 176 can access data 182 of enterprise base system 180. Similarly, enterprise base system 180 may include remote functions that are accessed through one or more remote function calls (RFCs) 184, and one or more web services 186. External service 178 accesses elements remote elements (for example, RFC 184 and web service 186).

Metadata 106 represents an abstraction of one or more data and/or access/service resources that may be accessed and utilized by design-time components 102 and run-time components 104. Metadata 106 is not necessarily a resource within one of the components, nor is it to be understood as being only available to the components. Metadata 106 provides a repository that includes metadata about business objects, business services, business processes, and/or other application portions for use in modeling and/or executing the application portions. Thus, an application portion may be modeled, as well as the origin of the data, whether in a local database, remote database, or a combination of the two. In one embodiment, the content of metadata 106 includes information extending beyond a specific implementation of an application portion. There could be repositories that describe a specific implementation, which may be filled from a more general repository. Metadata 106 can be understood as including a general, a specific, or a combination of repository information.

Workflow interface manager 190 represents a means for providing cross-system interfacing. Workflow interface manager 190 provides access in a one interface type to workflow activities that are native to another interface type. The access may be provided to a requesting interface type, or may be requested from one interface type to be accessed in another interface type that is different from the native interface type of the workflow activity. Thus, a workflow activity of any interface type may be requested from any interface type, and accessed in any interface type. Workflow interface manager 190 can determine what activities can be rendered and processed in the different interface type. Workflow activities may be completed in the different interface type and updated in the backend enterprise system.

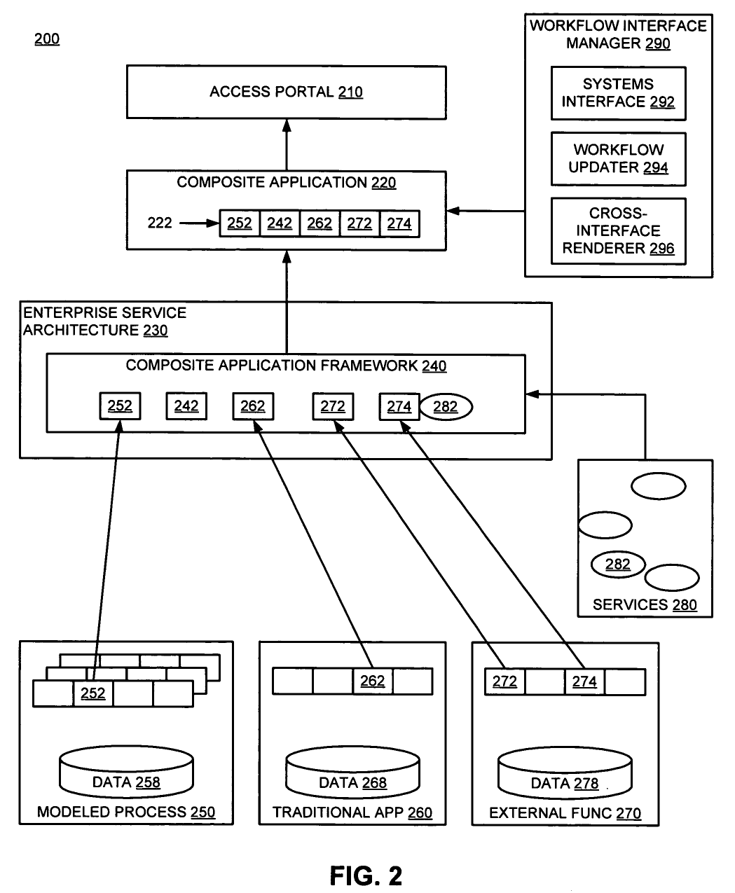

FIG. 2 is a block diagram of an embodiment of a composite application architecture. System 200 includes an enterprise service architecture through which workflows can be accessed and possibly worked on from a number of different interface types. Access portal 210 may be any type of network portal or access through which an enterprise may be accessed. For example, access portal 210 may include a network interface, a secure portal, a wireless interface, a connection to a public phone system, connections to public networks, etc.

System 200 may include multiple types of sources for functionality that are combined as a composite application. For purposes of example, and not by way of limitation, a composite application will be considered that includes components from several functionality sources. The use of different sources of functionality should not be understood as a requirement to the development of a dynamic data view as described herein. Examples of potential sources of functionality include modeled process 250, traditional application 260, and external functionality 270.

Modeled process 250 includes one or more processes that are generated from modeled components, for example, according to a framework as described in FIG. 1. Modeled process 250 includes data 258, which represents data related to the processes of modeled process 250. One element of a process is phase 252, which may include certain actions or activities or guided procedures.

Traditional application 260 includes one or more processes generated from a more traditional application. In this case, a more traditional application is one that is not modeled, in contrast to modeled process 260. Rather than being modeled and generated, traditional application 260 may include proprietary functionality, or services and data not based on a standard components available across sub-systems. Traditional application 260 includes data 268, which represents data related to the process of traditional application 260. One element of the process is phase 262, which may include functionality desired for a dynamic composite view. Traditional application 260 and modeled process 250 may understand the underlying framework and system in which the composite application will be instantiated. Thus, phases 252 and 262 may be contextually aware.

External function 270 includes one or more processes available outside the environment of the enterprise system. For example, external function 270 may represent a function available from a program that is a third-party as to the enterprise system. External function 270 may be a remote function that is accessed and executed. Phases 272 and 274 represent phases of a process of external function 270 that are desired for a composite application. Metadata may be included when bringing in components from external function 270, which can serve as a wrapper to incorporate the external functionality.

Services 280 represent one or more services that can provide a service to a composite process. Services 280 include service 282, which provides a service to be incorporated into the composite process of a composite application.

The selected process phases and service(s) are pulled in to enterprise service architecture 230 through composite application framework 240. Composite application framework 240 is a framework according to an embodiment of Framework 100 of FIG. 1. A process phase may also be generated within the framework that is not pulled from existing processes. For example, composite application framework may model phase 242 as an element of the composite application process. Each of the phases and services selected for a composite application are combined to generate composite application 220, which includes composite process 222 generated of the various selected elements. Namely, phases 252, 242, 262, 272, and 274 are combined to form composite process 222 that is accessible to a user through access portal 210.

In one embodiment, the system of FIG. 2 includes workflow interface manager 290. Workflow interface manager 290 provides management of items provided in composite application 220. In one embodiment, composite application 220 provides a dashboard or a work center from which any workflow item may be accessed (depending on user identity, permissions, authorizations, etc.). One or more of the various components that were combined to generate composite application 220 could provide functionality for use in accessing workflow items native to a particular interface type, and providing them to a user in another interface type. In one embodiment, workflow interface manager 290 is part of composite application 220.

Workflow interface manager 290 includes one or more modules that provide management of workflow items in composite application 220. For example, in one embodiment, workflow interface manager 290 includes systems interface 292 to enable access to the various systems from which workflow items may be generated (e.g., calendar, “to do” lists, email, voicemail, etc.). In one embodiment, in addition to accessing the items, a user may be able to perform work on a workflow item from a different interface type than that native to the workflow item. Workflow updater 294 enables workflow interface manager 290 to dynamically change the status of, or the data associated with a workflow item, depending on the work performed in the accessing interface, or the interface that accesses the workflow item. Workflow updater 294 enables the change to the workflow item even when the item is being accessed in a non-native interface type. Thus, a workflow item can be changed in the enterprise from work performed in the accessing interface. For purposes of example, the following descriptions assume that the requesting and the accessing interfaces are the same. However, this is not necessarily the case, and any implementation that refers to the requesting interface accessing a workflow item should be understood to apply equally well to an implementation where the accessing and requesting interfaces are not necessarily the same. In one embodiment, the requesting interface may be of the same type as the workflow item, and the accessing interface type is different from that same type.

Workflow interface manager 290 includes cross-interface renderer 296, which enables workflow interface manager 290 to provide the workflow item in a different interface type. Thus, through workflow interface manager 290, a user may be able to “see” that various workflow items exist, independently of what interface type the user is working from. With cross-interface renderer 296, the user may be able to actually bring up the workflow item in the different interface type and not just see the existence of the workflow item, but access the content of the workflow item itself. In one embodiment, cross-interface renderer 296 is enabled to determine whether the workflow item is presentable in the requesting interface, or to what extent the workflow item is renderable in the requesting interface. For example, cross-interface renderer 296 may determine that an email can be converted from text to speech and read to a user requesting the workflow item from a mobile phone. Alternatively, cross-interface renderer 296 may determine that a 40 page attachment should not be converted from text to speech.

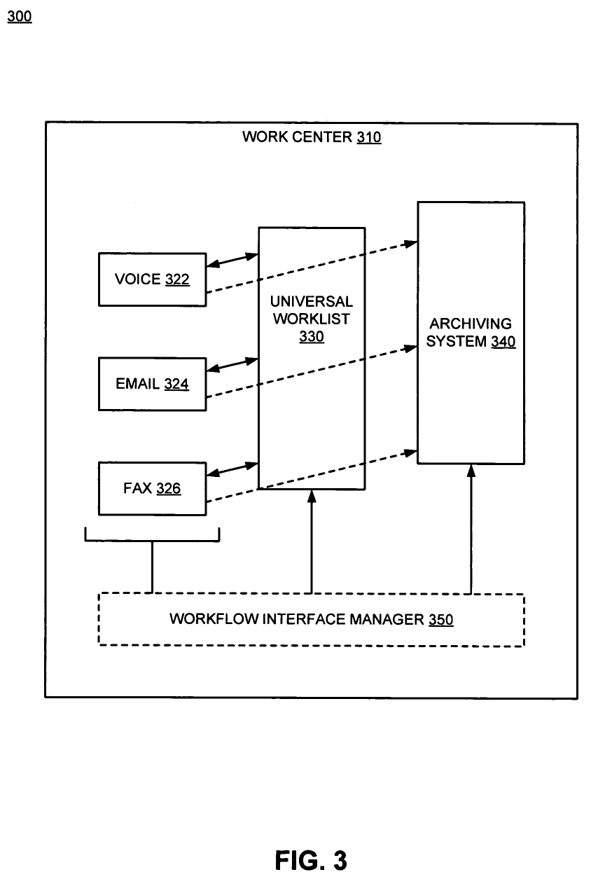

FIG. 3 is a block diagram of an embodiment of a work center having cross-system workflow interfacing. System 300 includes work center 310, which provides one example of a work center or employee dashboard on which a worklist may be provided. In one embodiment, work center 310 is a composite application that provides dynamic viewing and accessing to workflow activities. Work center 310 has access to one or more backend systems or clients to the systems that can be the source for workflow activities, for example, voice 322, email 324, and fax system 326. Others are possible. Voice system 322 may include any of a number of voice interfaces and may include a voice backend system such as voicemail.

The various components of FIG. 3 and other figures can be considered to be coupled together. The coupling of components may include physical coupling, communicative coupling, and/or electrical coupling. Thus, coupling may refer to direct physical interconnection, as well as indirect interconnection. Coupling of physical components can be accomplished with buses, signal lines, wireless links, etc. The coupling of software components can be accomplished, for example, through interfaces (e.g., APIs (application programming interfaces)), function calls, etc.

Voice 322, email 324, and fax system 326 can provide workflow activities that are unified in universal worklist 330 via workflow interface manager 350. Rather than being separate worklists tied to the interface type from which the workflow activity was generated, universal worklist 330 include the activities from any interface type.

Work center 310 can also act as an archiving system. With universal worklist 330, and access to each of the different systems, regardless of interface type or interface client, work center 310 provides archiving system 340 that includes a record of all workflow activities from the various different client types. Workflow interface manager 350 coordinates and manages the accessing and working on the various systems.

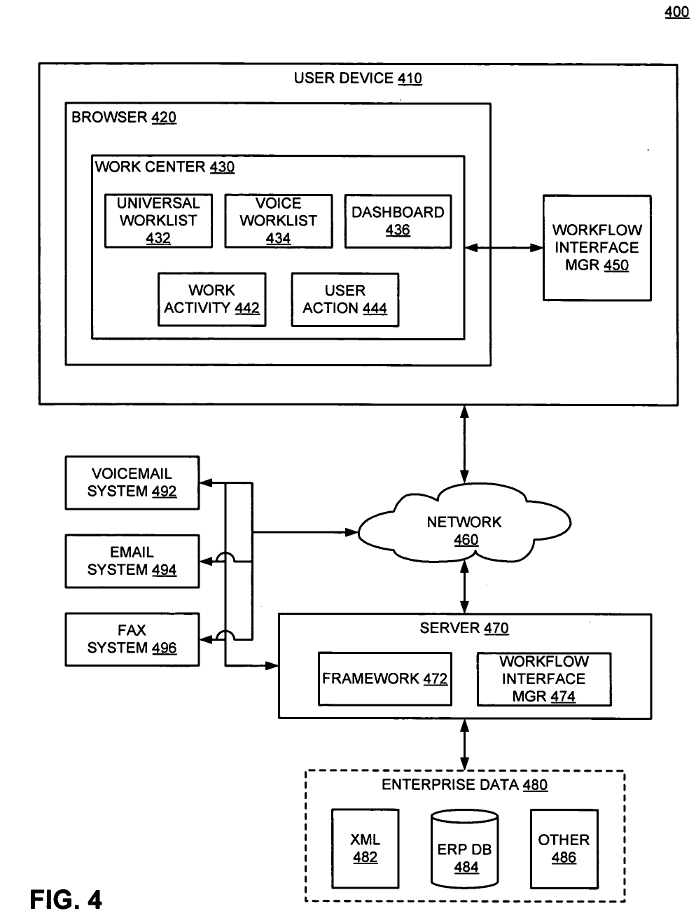

FIG. 4 is a block diagram of an embodiment of a user device with a work center having cross-system workflow interfacing. System 400 includes user device 410, which represents a computer device on which a user accesses the various systems of an enterprise. In one embodiment, user device 410 includes browser 420, which represents a web browser or program that acts as a user agent with which to access network content. Browser 420 provides one example of a program that can be used to display a work center or other composite application. In one embodiment, browser 420 includes work center 430, which represents one type of composite application that can be generated from enterprise data with a framework. Work center 430 further includes universal worklist 432, voice worklist 434, one or more dashboards 436, work activity 442, and user action 444.

Work center 430 represents one or more applications in which to perform work-level actions. Work center 430 displays data objects and other information in a dynamic view to a user, and enables access to the various items displayed. Universal worklist 432 provides one example of a worklist that can exist within work center 430. Note that worklists can be dynamically created within work center 430, and are presented to a user, and updated as the content of the worklist changes. The worklist is ultimately connected to the underlying enterprise systems, and represents a particular view on enterprise-level data. In addition to a universal worklist, work center 430 may include voice worklist 434, or another worklist. Voice worklist 434 represents work activities for a user of work center 430 that can be performed via a voice interface. Alternatively to a separate worklist, universal worklist 432 could have certain items flagged as being suitable for voice interfacing. As another alternative, universal worklist 432 could display all workflow activities the same to the user, and in response to a user request, the user can be informed whether or not a particular workflow activity is suitable for a requesting interface channel. Dashboard 436 provides another example of a display in which work center 430 can provide access to work. Dashboard 436 may relate to a particular project or a particular role.

The worklists, dashboards, or other mechanisms of a work center ultimately provide a user with work activities to perform, represented by work activity 442. Work activity 442 can be native to an interface type, and renderable to other interface types. When a user performs an action on the work activity, user action 444 is generated, which represents something the user does to affect work activity 442. User action 444 may be evaluated to determine what affect it may have on the underlying system-level data associated with work activity 442.

Workflow interface manager (mgr) 450 coordinates the ability of work center 430 to provide access to work activities of differing interface types. Workflow interface manager 450 may be part of work center 430, or may be a distinct composite application that executes in a background, not visible to a user.

User device 410 is coupled to network 460. Network 460 may include any type of network, and represents both hardware and software or network protocol(s) with which user device 410 accesses server 470, and/or other enterprise system components (e.g., voicemail system 492, email system 494, and fax system 496). Network 440 may include a local area network (LAN), a wireless LAN (WLAN), a virtual private network (VPN), virtual LAN (VLAN), wide area network (including the Internet), etc.

Server 470 includes framework 472 to generate work center 430. Server 470 is an enterprise server and provides access to one or more services. The services provide access to enterprise data 480, which can include any type of data or information, and may include for example, extensible markup language (XML) data 482, enterprise resource planning database (ERP DB) 484, or other data 486. There is no limitation on the type of data accessible from server 470, except through the permissions provided through an authorization of the user.

In one embodiment, server 470 includes one or more components of a workflow interface manager, represented by workflow interface manager 474. Note that workflow interface manager 474 and workflow interface manager 450 are not necessarily the same. In one embodiment, workflow interface manager 450 is an instantiation of workflow interface manager 474. Workflow interface manager 474 may represent components stored within the enterprise that enable workflow interface manager 450. For example, workflow interface manager 474 may represent one or more business object agents that interface workflow item business objects, an alert interface module to pass alerts or reporting information to work center 430 regarding cross-interface workflow access, etc.

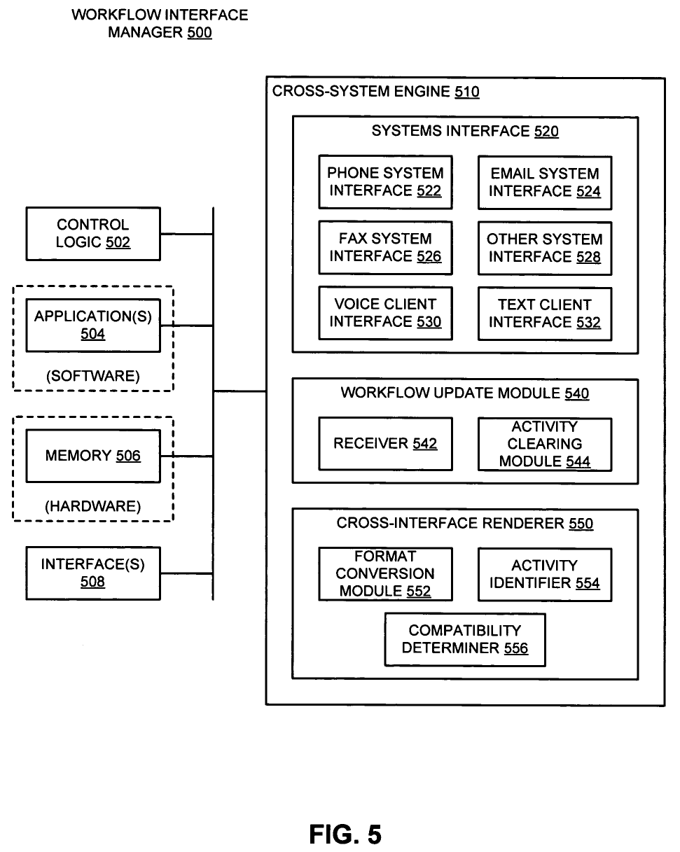

FIG. 5 is a block diagram of an embodiment of a workflow interface manager. Workflow interface manager 500 includes control logic 502, which implements logical functional control to direct operation of workflow interface manager 500, and/or hardware associated with directing operation of workflow interface manager 500. Each of the components represented in workflow interface manager 500 is a means that may be implemented with hardware, software, or a combination. Logic 502 may be hardware logic circuits and/or software routines. In one embodiment, the logic may be instructions executing on a processor of a computing device. Thus, in a software implementation, logic 502 provides instructions for the control of operation of a processor that executes workflow interface manager 500. In a hardware implementation, logic 502 represents circuitry that provides functional control (e.g., outputs on a signal line). Logic 502 may also refer to the operating instructions and circuitry that control, for example, an embedded processor in an implementation with software and hardware combined.

In one embodiment, in an implementation that is partially or wholly software, workflow interface manager 500 includes one or more applications 504, which represent code sequences and/or programs that provide instructions to control logic 502. Applications 504 may be code executing on a common processor that executes workflow interface manager 500.

In one embodiment, workflow interface manager 500 includes memory 506 and/or access to memory resource 506 for storing data and/or instructions. In a hardware implementation, a hardware circuit that represents workflow interface manager 500 may include a memory device. In a software implementation, memory 506 can be understood to refer to the ability of a software module to store data in memory and access registers for the execution of code. Thus, memory 506 may include memory local to workflow interface manager 500, as well as, or alternatively, including memory of a storage server on which workflow interface manager 500 resides.

Workflow interface manager 500 also includes one or more interfaces 508, which represent access interfaces to/from (an input/output interface) workflow interface manager 500 with regard to entities external to workflow interface manager 500. In one embodiment, workflow interface manager 500 is accessible as a component of a system (e.g., a filer) that can be manipulated externally by a user through a user interface. Thus, interfaces 508 may include graphical user interfaces, keyboards, pointer devices, etc., in an implementation where workflow interface manager 500 is accessible to human users. In an alternative embodiment, workflow interface manager 500 executes “behind the scenes” to a human user, meaning the module performs its functions without being visible to the human user. However, even if not visible to a human user as a separate component, workflow interface manager 500 can be accessible to external electronic components, or external software applications. Thus, in one embodiment, interfaces 508 include mechanisms through which external programs may access the module (e.g., drivers in a hardware implementation of workflow interface manager 500, application program interfaces (APIs) in a software implementation, etc.).

Workflow interface manager 500 also includes cross-system engine 510, which represents one or more functional components that enable workflow interface manager 500 to provide access to workflow items across different interface types. Cross-system engine 510 may be implemented as hardware and/or software, and provides the functionality of workflow interface manager 500. The functions or features of the components include, or are provided by, one or more means, including systems interface 520, workflow update module 530, and cross-interface renderer 540. Each module may further include other modules to provide specific functionality. As used herein, a module refers to routine, a subsystem, etc., whether implemented in hardware, software, or some combination. One or more modules can be implemented as hardware while other(s) are implemented in software.

Systems interface 520 enables cross-system engine 510 to interface with various different system interface types or various different system clients. Systems interface 520 enables accessing workflow activities of the various different systems. For example, systems interface 520 may include phone system interface 522 to access a phone system and retrieve voicemail activities, email system interface 524 to access workflow activities generated in email, fax system interface 526 for fax items, and/or other system interface(s) 528 to another type of system not specifically named here. Additionally, systems interface 520 can include interfaces for the different channel types.

In one embodiment, access to the various systems 522-528 to retrieve workflow activities can be assumed to include the ability to access the system to present workflow activities to a user. In an alternative embodiment, access to the various systems 522-528 allows systems interface 520 to obtain the workflow activities, and generic interfaces are employed to present the workflow activities based on a compatibility of the system with the client interface type. For example, systems interface 520 may include voice client interface 530 to provide workflow items over any type of voice channel (e.g., phone system, media player). Systems interface 520 may also include text client interface 532 to provide workflow items over any type of text-compatible channel (e.g., email, calendars, etc.).

Workflow update module 540 enables cross-system engine 510 to update the underlying enterprise system when work on a particular workflow activity is performed in a different interface type. Workflow update module 540 includes receiver 542 that receives and processes work actions generated by users on workflow activities. For example, receiver 542 may include an input system that processes voice commands, key tones, check-box documents, text submissions, etc., which may be generated by a user for a workflow activity received on a requesting interface. Despite the requesting interface type being different than an interface type of the workflow activity, receiver 542 receives and processes the input. Workflow update module 540 also includes activity clearing module 544 that determines from the work action of the user whether the work activity is completed by the work action. If the work action is determined to complete the work activity, the work activity is cleared from the system, and the workflow status is updated to a subsequent activity. If activity clearing module 544 determines that the work action does not clear the workflow activity, other action can be taken. For example, a log of the work action can be generated to make a record of what the user has done with the work activity. Alternatively, the work activity may remain unaffected in the system if the work action does not complete the activity.

Cross-interface renderer 550 enables cross-system engine 510 to render a workflow activity of one system or of a first interface type into a second interface type. Thus, the content of a workflow activity native to a particular interface type is accessible in another interface type. Cross-interface renderer 550 includes format conversion module 552 that can render a workflow activity into a format suitable for access by the non-native interface type. A simple example is text-to-speech. Similarly, faxes can be rendered into electronic document format and provided to another interface type. Speech-to-text is also possible. Format conversion module 552 may include any one or more conversion engines to provide the format conversion. In one embodiment, a conversion is available as part of the system being interfaced. For example, many fax systems provide electronic documents of faxes received. In such a case, format conversion module 522 may simply access the converted workflow activity to present it in the other system.

In one embodiment, cross-interface renderer 550 includes activity identifier 554, which provides the ability to identify one or more workflow activities as being native to particular interface types, or being compatible with particular interface types. The identification can include storing a table or database of information identifying each workflow activity of a user's worklist. Alternatively, the enterprise itself can store information in the enterprise server(s) regarding types of workflow activities, and the types of interfaces with which the activities are compatible, or to what extent they are compatible. Metadata can also be stored with each workflow activity to identify it as belonging to a particular type of workflow activity, or being compatible with particular interface types. The metadata can be specific to determining compatibility with different interfaces (i.e., metadata specifying compatibilities), or can be metadata about the work activity that defines properties of the work activity through which a compatibility determination can be made (e.g., type of activity, native interface, size of the associated data, input type required, etc.). Thus, identification of workflow activities can include operations performed independent of specific workflow activities, and/or specific to a particular workflow activity.

Compatibility determiner 556 of cross-interface renderer 550 can determine, based on an identification of a workflow activity (either by the workflow interface manager, or an identification assigned when the activity was generated, etc.), whether a particular workflow activity is compatible with a requesting interface type. In one embodiment, compatibility determiner 556 includes heuristics information to determine whether a requested workflow activity is compatible with being worked on in a requesting interface type. Compatibility determiner 556 may include any type of analytics for making the determination. Compatibility determiner 556 may include rules tables/databases, determination algorithms, etc. In one embodiment, compatibility determiner 556 receives metadata associated with the workflow activity as input to a compatibility determination algorithm. The metadata can be or specify rules for the algorithm to make a determination. Compatibility can be determined as a binary condition (i.e., yes/no), or as a graduated condition (e.g., certain parts of the workflow activity but not others, compatible if a particular feature or application is enabled, etc.).

The descriptions herein of managers or modules, describe components that may include hardware, software, and/or a combination of these. In a case where a component to perform operations described herein includes software, the software data, instructions, and/or configuration may be provided via an article of manufacture by a machine/electronic device/hardware. An article of manufacture may include a machine readable medium having content to provide instructions, data, etc. The content may result in an electronic device as described herein, performing various operations or executions described. A machine readable medium includes any mechanism that provides (i.e., stores and/or transmits) information/content in a form accessible by a machine (e.g., computing device, electronic device, electronic system/subsystem, etc.). For example, a machine readable medium includes recordable/non-recordable media (e.g., read only memory (ROM), random access memory (RAM), magnetic disk storage media, optical storage media, flash memory devices, etc.). The machine readable medium may further include an electronic device having code loaded on a storage that may be executed when the electronic device is in operation. Thus, delivering an electronic device with such code may be understood as providing the article of manufacture with such content described herein. Furthermore, storing code on a database or other memory location and offering the code for download over a communication medium may be understood as providing the article of manufacture with such content described herein.

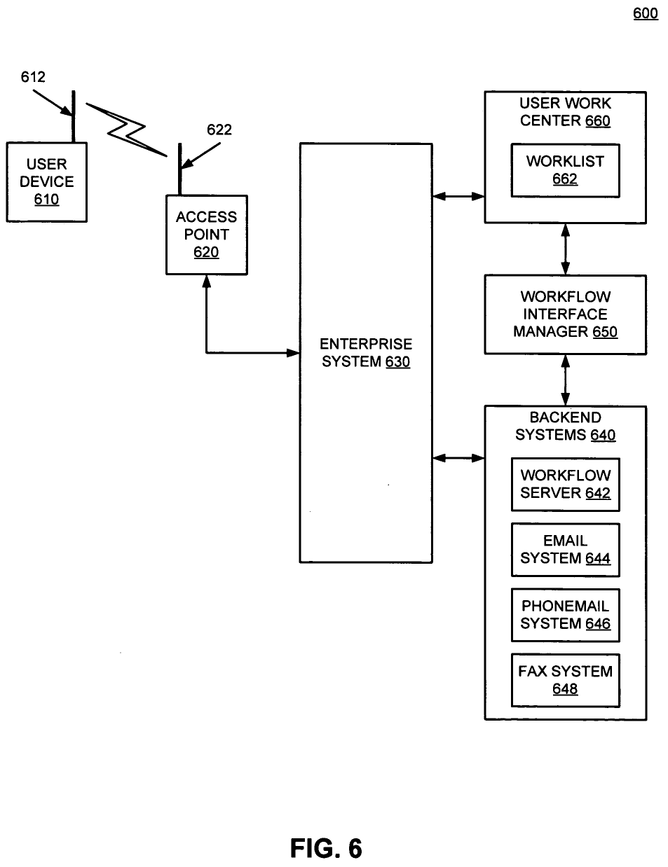

FIG. 6 is a block diagram of an embodiment of wireless user device coupled to an enterprise having a workflow interface manager. System 600 includes user device 610, which represents a wireless communication device, such as a mobile phone. User device 610 communicates over a wireless communication link to access point 620, which represents an access point for a mobile device to connect to a landline. Access point 620 may be, for example, a base station. User device 610 includes antenna 612, and access point 620 includes antenna 622, which may be omnidirectional (e.g., dipole) antennas, or directional antennas. Either or both of antennas 612 and 622 may represent antenna systems having multiple antennas that use diversity and/or smart antenna processing.

Access point 620 is coupled to enterprise system 630 via a landline. The landline may include any number of components for routing, switching, processing, repeating, etc., the signal. The landline may additionally include any of a number of known transmission media, including fiber, copper or other metal wiring, etc. Enterprise system 630 represents one or more hardware and software components that provide a company's IT (information technology) infrastructure.

Enterprise system 630 typically includes several backend systems 640, which may include workflow server 642, email system 644, phonemail system 646, and fax system 648. Other systems may also be included. Workflow server 642 provides business objects that are related in a workflow. A workflow refers to data and operations to execute with respect to the data in order to accomplish one or more aspects of the company's work, or a work process. Examples may include anything from an employee evaluation workflow to a receipt of payment workflow. Each aspect of a workflow may be a work activity or a work task that requires something to be done (e.g., data updated, data input, generation of a product, movement of goods or data, etc.) in order to complete the work activity. Each work activity can be assigned to a responsible person through enterprise system 630. The work activities are presented to an enterprise user through, for example, user work center 660 in worklist 662. User work center 660 and worklist 662 represent work centers and worklists as previously described herein. User work center 660 is a work center as accessed by a user from a requesting interface type.

System 600 includes workflow interface manager 650, which represents a workflow interface manager according to any embodiment described herein. Workflow interface manager 650 enables worklist 662 of work center 660 to provide access to any format of workflow item to any requesting client. Additionally, certain workflow items may be able to worked on the requesting client. In some cases, work actions performed in the requesting client can provide data or operations necessary to complete the work activity. In such a case, the work activity can be cleared in enterprise system 630 based on the activity by the user from the requesting interface type.

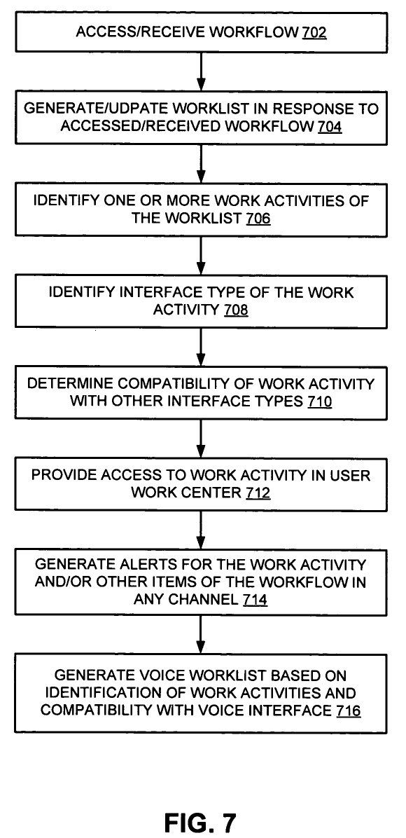

FIG. 7 is a flow diagram of an embodiment of a process for providing access in one system to compatible workflow items of another system. The flow diagrams illustrated herein provide examples of sequences of various operations. Although shown in a particular sequence or order, unless otherwise specified, the order of the operations can be modified. Thus, the illustrated implementations should be understood only as examples, and operations can be performed in a different order, and some operations may be performed in parallel. Additionally, as provided in the description above, not all of the operations shown are necessarily required.

Workflow activities, or work activities are combined in a single worklist that provides access to the work activities. Activities can be added to the worklist in a number of ways. For example, in response to a request for a particular workflow, work activities related to the workflow may be accessed, or the work activity can be generated and sent to the work center, 702. Work activities can be accessed in conjunction with a loading or starting up of a work center, as well as during run time of the work center. If the work center is being initiated, the worklist may be generated in response to the accessing of the workflow, 704. If the work center is executing and a new work activity is received, the worklist may be updated in response to receiving the work activity, 704.

A user may request a worklist, or a particular work activity of the worklist, for example, to perform operations on the work activity. A workflow interface manager receives the request from a requesting interface of the user. In one embodiment, in response to the request, the workflow interface manager identifies one or more work activities of the requested worklist. In another embodiment, the workflow interface manager identifies one or more work activities in response to receiving a request for the specific work activities, 706. The one or more identified work activities have an associated interface type (i.e., the native interface type). The workflow interface manager identifies the interface type of the work activity, 708. In one embodiment, identifying the interface type of the work activity is performed in response to receiving the request for the activity, or in response to identifying the work activity. In another embodiment, the interface type of the work activity is identified prior to a request for a worklist or for a particular work activity. The work activity can be identified by interface type as part of generating the worklist, and/or as part of generation of the work activity.

The workflow interface manager optionally determines a compatibility of the identified interface type of the work activity with the requesting interface type, 710. As discussed above, such a determination, if made, can indicate either compatibility/incompatibility, or may indicate compatibility in degrees of compatibility. The workflow interface manager provides access to the requesting interface to the work activity in the user work center, depending on a compatibility of the work activity with the requesting interface type, 712. In addition to allowing access to the work activity, the workflow interface manager may generate alerts for the work activity and/or other items of the workflow, 714. In contrast to what is traditionally possible, where alerts matched the interface type of the workflow item, the workflow interface manager can provide the alerts over any channel. In one embodiment, the workflow interface manager identifies work activities that are compatible with a voice interface, and generates a voice worklist based on identification of work activities and compatibility with the voice interface, 716.

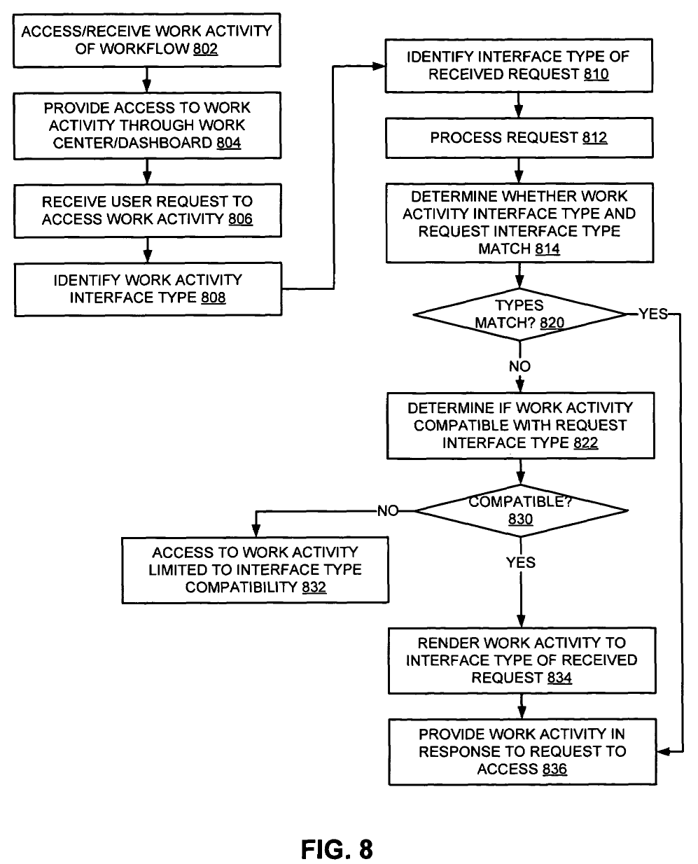

FIG. 8 is a flow diagram of an embodiment of a process for accessing a workflow activity in a non-native system. A workflow interface manager accesses or receives a work activity of a workflow, 802. The workflow interface manager provides access to the work activity through a work center and/or dashboard, 804. The work center or dashboard provides an interface where a user can access the work activity. The workflow interface manager receives a user request to access the work activity, 806. The request is received over a particular interface type, and the work activity has a native interface type. The workflow interface manager identifies the work activity interface type, 808, as well as the interface type or channel of the received request, 810. The workflow interface manager processes the request, 812, to determine what the user is requesting to do with the work activity (e.g., view, work on it, receive alerts, etc.). The workflow interface manager determines whether there is a match between the work activity interface type and the request interface type to perform what the user is requesting to do, 814. If the types match, 820, the workflow interface manager provides the work activity to the user in response to the request to access the work activity, 836.

If the interface types do not match, 820, the workflow interface manager determines if the work activity is compatible with the request interface type, 822. Note that an interface type match is a simple case, and no cross-rendering would need to be provided. However, even if the interface types do not match, they may be compatible for cross-rendering. If the interface types are not compatible, 830, the workflow interface manager limits access to the work activity from the requesting interface according to interface compatibility, 832. For example, receiving alerts may be compatible, but working on the work activity may not be possible from the requesting interface type.

If the interface types are determined to be compatible, 830, the workflow interface manager renders the work activity to the interface type of the received request, 834. The workflow interface manager can then provide access to the work activity in response to the request to access the work activity, 836.

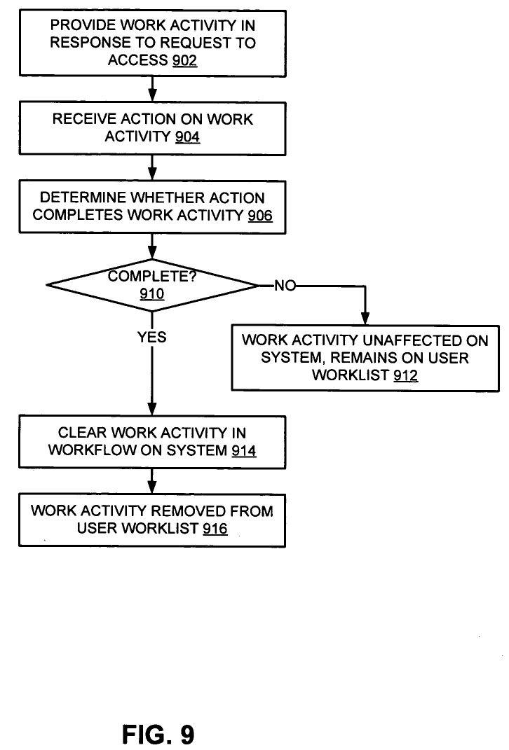

FIG. 9 is a flow diagram of an embodiment of a process for completing a workflow activity in a non-native system. The workflow interface manager provides access to a user to a work activity in response to a request to access the work activity, 902. The user may work on the work activity from a compatible interface type, and thus generate an action on the work activity. The action is received by the workflow interface manager, 904. The workflow interface manager determines whether the action completes the work activity, 906.

If the work activity is not completed by the received action, 910, the work activity remains unaffected in the system, and remains on the user worklist, 912. If the work activity is completed by the action, 910, the workflow interface manager clears the work activity in the workflow on the enterprise system, 914. The work activity is then removed from the user worklist, 916, and the workflow is able to proceed to a subsequent work activity.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method for accessing a workflow item, comprising:
accessing a work activity of a workflow of an original interface type;
receiving a request to access the work activity from a different interface type; and
providing the work activity to the requested different interface type in response to the receiving the request, to enable an operation on the work activity of the workflow from the different interface type.

2. The method of claim 1, wherein the original interface type and the different interface type are separate elements selected from the group consisting of: an email system, a voice system, and a facsimile system.

3. The method of claim 1, wherein accessing the work activity of the workflow comprises:
accessing the work activity from an integrated worklist of workflow activities in a work center, the integrated worklist including work activities from multiple interface types.

4. The method of claim 3, wherein accessing the work activity from the integrated worklist further comprises:
identifying work activities of the integrated worklist that can be rendered in a different interface type.

5. The method of claim 1, wherein providing the work activity to the requested different interface type further comprises:
converting the work activity from a format associated with the original interface type to a format associated with the different interface type to make the work activity renderable in the different interface type.

6. The method of claim 1, wherein providing the work activity to the requested different interface type to enable the operation on the workflow from the different interface type further comprises:
identifying the operation on the workflow;
determining whether the operation on the workflow completes the work activity; and
clearing the work activity from the workflow if the operation on the workflow completes the work activity.

7. The method of claim 1, further comprising:
determining an extent to which access to the work activity of the workflow is possible in the requested interface.

8. The method of claim 7, wherein determining the extent to which access to the work activity is possible in the requested interface further comprises:
accessing a rules list that matches work activities to levels of compatibility to interface types.

9. An article of manufacture comprising a machine readable medium having content stored thereon to provide instructions to cause a machine to perform instructions, including:
accessing a work activity of a workflow, the work activity native to a first access channel;
receiving a request to access the work activity over a second access channel;
determining an extent to which access to the work activity is possible over the second access channel; and
providing the work activity over the second access channel in response to the receiving the request, to enable an operation on the work activity from the second access channel.

10. The article of manufacture of claim 9, wherein the content to provide instructions for accessing the work activity comprises:
content to provide instructions for accessing the workflow from a user dashboard.

11. The article of manufacture of claim 9, wherein the content to provide instructions for determining the extent to which access to the work activity is possible comprises:
content to provide instructions for determining a compatibility of the work activity with the second access channel based on metadata associated with the work activity.

12. The article of manufacture of claim 11, wherein the content to provide instructions for determining the compatibility based on the metadata comprises:
content to provide instructions for applying a compatibility algorithm with the metadata as rules for the compatibility algorithm.

13. The article of manufacture of claim 9, wherein the content to provide instructions for determining the extent to which access to the work activity is possible further comprises:
content to provide instructions for limiting access to the work activity from the second channel according to an extent to which the work activity and the second access channel are compatible.

14. The article of manufacture of claim 9, wherein the content for providing the work activity over the requesting second access channel in response to the receiving the request further comprises:
content to provide instructions for providing the work activity in a multimodal manner over the requesting second access channel and over a third access channel in response to the receiving the request.

15. The article of manufacture of claim 9, wherein receiving the request to access the work activity over the second access channel comprises:
receiving the request from a third access channel.

16. The article of manufacture of claim 15, wherein the third access channel is of the same type as the first access channel.

17. The article of manufacture of claim 9, wherein receiving the request to access the work activity over the second access channel comprises:
receiving the request from the second access channel.

18. A workflow interface manager comprising:
a systems interface module to receive from a first system having a first interface type a request to access a workflow task from a second system having a second interface type; and
a cross-interface renderer coupled to the systems interface to render the workflow task of the second system to the first interface type for access to the workflow task via the first system.

19. The workflow interface manager of claim 18, wherein the first system comprises an item selected from the group consisting of: an email system, a calendar system, and a “to do” task list.

20. The workflow interface manager of claim 18, wherein the cross-interface renderer is to further identify whether the workflow task is compatible with a voice interface; and
wherein the systems interface module is to further include the workflow task to a voice worklist in response to the cross-interface renderer determining that the workflow task is compatible with a voice interface.

21. The workflow interface manager of claim 18, wherein the cross-interface renderer rendering the workflow task to the first interface type comprises rendering the workflow task from text to speech.

22. The workflow interface manager of claim 18, further comprising:
a workflow update module to receive an operation on the workflow task from the second system having the second interface type and determine whether the operation completes the workflow task.

23. The workflow interface manager of claim 22, wherein the workflow update module receives the operation over a voice channel.
